(19) United States
(12) Patent Application Publication
(10) Pub. No.: US 2015/0131927 A1
(43) Pub. Date: May 14, 2015

(54) PLASTIC BAG BODY HAVING A PLASTIC ZIPPER WITH A SLIDER EQUIPPED THEREWITH AND ADDED THERETO A PREVENTIVE FUNCTION AGAINST UNFAIRLY UNSEALING, AND METHOD FOR MANUFACTURING THE SAME

(71) Applicant: JUICHI KASAI, Tokyo (JP)

(72) Inventor: JUICHI KASAI, Tokyo (JP)

(21) Appl. No.: 14/564,805

(22) Filed: Dec. 9, 2014

Related U.S. Application Data
(63) Continuation of application No. 12/972,990, filed on Dec. 20, 2010.

(30) Foreign Application Priority Data
Dec. 24, 2009 (JP) 2009-292093

(51) Int. Cl. B65D 33/25; B31B 1/90; B31B 1/64; B65D 75/58; B31B 1/25

(52) U.S. Cl. CPC B65D 33/2533; B65D 75/5844; B65D 33/2575; B31B 1/25; B31B 1/64; B31B 1/90
USPC 383/204; 383/64; 493/189; 493/213; 493/240

(57) ABSTRACT

A plastic bag body having a preventive function against unfairly unsealing and having a plastic zipper with a slider equipped therewith is provided by which hermetic sealing can be kept, and which can be produced mechanically and successively at an excellent productivity. In a bag body comprising a bag made of two plastic films, both ends of which are welded, and having plastic zipper with a slider at an opened portion of the bag, a cover film rides astride and covers top portions of the plastic slider, under a condition wherein the plastic zipper is closed, and of the plastic zipper, except for a welded portion located opposite to the slider of the bag body, at least one lower end of the cover film extending for full width of the bag body, and the plastic film, the lower ends of the cover film and the flange portions are welded together.

### CROSS REFERENCE TO RELATED APPLICATION(S)

This application is a continuation of U.S. patent application Ser. No. 12/972,990, filed Dec. 20, 2010, which claims the benefit of Japanese Patent Application No. 2009-292093 filed Dec. 24, 2009, the disclosure of which is incorporated herein in its entirety by reference.

### TECHNICAL FIELD

The present invention relates to a plastic bag body having a plastic zipper with a slider equipped therewith and added thereto a preventive function against unfairly unsealing. The bag body having a plastic zipper with a slider equipped therewith can be easily opened and re-closable while keeping a hermetic sealing property and it is widely used as packing materials for foods, medicines, electronic products and so on.

The present invention also relates to a method for manufacturing such a bag body having a preventive function against unfairly unsealing and having a plastic zipper with a slider equipped therewith.

### BACKGROUND ART

As described above, bag bodies equipped with plastic zippers are widely used as packing materials for various goods, such as foods, medicines, electronic products and so on. Especially, bag bodies equipped with plastic zippers with sliders are widely used as packing materials which are easily opened and re-sealable.

With diversification of contents of packages, further more advanced air tightness has been required for such bag bodies.

Further, in such a bag body, various troubles, such as mixing of foreign substances or spoiling of quality of contents in the package, may cause, if the bag body is opened by wrong purpose or by an inaccurate error after it has been hermetically sealed. Therefore, it has been desired to add to a bag body having a zipper with a slider a function that broken seal after hermetical seal can be detected.

Conventionally, various bag bodies equipped with plastic zippers and having such a preventive function against unfairly unsealing as described above have been proposed. Among them, the following bags have been known as closely relevant to the present invention.

In patent document 1 (Japanese Utility Model Application Laid-open No. S62-90332), it is disclosed that, in a bag for keeping certificate having an open groove at a portion below a zipper, outside the zipper, a mouth cover plate covers a mouth portion except for the slider, and a sealing paper seals between the covered mouth covering plate and the open groove of the keeping bag, so that it can be readily detected that the certificate is used for another purpose other than the original purpose by opening the keeping bag.

The bag for keeping certificate disclosed in patent document 1 can not keep hermetic sealing due to the open groove formed on the bag, and therefore, it can not be used as a bag which requires hermetic sealing. Further, there are problems of low productivity when the bag for keeping certificate disclosed in patent document 1 is used as ordinary packaging bag, because operations for covering the mouth portion of the bag with the covering plate and for sealing with a seal paper are manually carried out.

In patent document 2 (WO 2005/048763 A1), FIGS. 14 and 15 disclose conventionally known bag bodies having zippers with sliders and added thereto a preventing function against unfairly unsealing wherein sliders and zippers at their upper portions are covered by cover films.

In the bag body having zippers with sliders, added thereto a preventing function against unfairly unsealing and disclosed in patent document 2 as prior art, the slider can be moved within the cover film. Therefore, if the slider is moved by mischief, the inside and the outside of the cover film are communicated to each other through perforations formed on the cover film, and there is a possibility that hermetic sealing is lost. However, it is difficult to distinguish whether or not such mischief has been done. Accordingly, there is a problem that occurrence of such unusual situation, wherein hermetic sealing is lost, can not be detected readily. Further, there are problems that a bag body having a zipper with a slider disclosed in patent document 2 is difficult to produce mechanically and consecutively, and its industrial productivity is inferior.

In patent document 3 (WO 00/67605), FIGS. 4a and 5b disclose bag bodies having zippers with sliders and added thereto a preventing function against unfairly unsealing wherein an adhesive label is adhered to the upper portion of the zipper except for the slider.

There are problems that the bag body having a zipper with sliders, added thereto a preventing function against unfairly unsealing and disclosed in patent document 3 is difficult to produce mechanically and consecutively, and its industrial productivity is inferior.

In addition, the bag body disclosed in patent document 3 has a disadvantage that when the label is adhered only at a part of the lengthwise direction of the zipper, unfairly unsealing at the remaining part, where the label has not been adhered and where unsealing may be manually done without moving the slider, can not be detected.

### PRIOR ART

### Patent Documents

[Patent document 1] Japanese Utility Model Application Laid-open No. S62-90332
[Patent document 2] WO 2005/048763 A1
[Patent document 3] WO 00/67605

### DISCLOSURE OF THE INVENTION

### Objects of the Invention

It is an object of the present invention to provide a bag body having a zipper with a slider equipped therewith and added thereto a preventive function against unfairly unsealing, which can solve the problems and disadvantages inherent to the above-described prior art.

More specifically, it is an object of the present invention to provide a bag body having a zipper with a slider equipped therewith and added thereto a preventive function against unfairly unsealing, which can keep hermetic sealing of the bag, which can be produced mechanically and consecutively, and its industrial productivity is superior.

Further, it is another object of the present invention to provide a bag body having a zipper with a slider equipped therewith and added thereto a preventive function against unfairly unsealing, wherein there is no possibility that hermetic sealing is lost even if the slider is moved by mischief.

Furthermore, it is a further object of the present invention to provide a method for manufacturing such a bag body having a zipper with a slider equipped therewith and added thereto a preventive function against unfairly unsealing as described above.

### The Means for Solving a Subject

According to the present invention, the above-described object is achieved by a plastic bag body having a preventive function against unfairly unsealing and having a plastic zipper with a slider equipped therewith, the bag body comprising a bag made of two plastic films, both ends of which are welded, and having the plastic zipper with the slider at an opened portion of said bag, wherein

a cover film rides astride and covers top portions of said plastic slider, under a condition wherein said plastic zipper is closed, except for said plastic slider and, a welded portion located opposite to said slider of said bag body, two lower ends of said cover film reaching flange portions locating below engaging portions of said plastic zipper, and at least one lower ends of said cover film extending for full width of said bag body,

lower ends of said cover film are put together with plastic films forming said bag body and with the flange portions of said plastic zipper, and

said plastic film, said lower ends of said cover film and said flange portions are welded together.

In the bag body, in order to prevent the slider from being moved by mischief, it is preferred that a distance between the slider in a condition wherein said plastic zipper is closed and the edge of said cover film adjoining to said slider is not more than 5 mm and/or that the top portion of said cover film is lower than the top portion of the slider in a condition wherein said plastic zipper is closed.

In order to facilitate easy opening of the bag body of the present invention, it is preferred that said cover film has a perforation or a weakened portion for separation, extending in a widthwise direction of said bag body, disposed thereon, and/or that said cover film has a grip at a position close to the welded portion of the bag body, the welded portion locating opposite to said slider in a condition wherein said plastic zipper is closed.

Furthermore, according to the present invention, the above-described object is achieved by a method for manufacturing a plastic bag body having a preventive function against unfairly unsealing and having a plastic zipper with a slider equipped therewith wherein it includes;

a step for supplying two continuous plastic films which form the bag;

a step for supplying to said two continuous plastic films a continuous plastic zipper and a two-folded continuous film for cover film having openings for installing the slider;

a step for supplying said two-folded continuous film for cover film in such a manner that it ride astride said plastic zipper;

a step for putting said two plastic films, said plastic zipper and said film for cover film together, and welding them in a supplying direction;

a step for welding said welded two plastic films, said plastic zipper and said film for cover film in a direction perpendicular to said supplying direction at a space, which is the same with width of a bag body, so as to form welded portions locating at both edges of the bag body;

a step for installing said slider to said plastic zipper through said openings for installing the slider; and

a step for cutting the welded portions, locating at both edges of the bag body and extending in a direction perpendicular to said supplying direction.

According to the present invention, the openings for installing the slider and notch portions for the welded portions, locating at both edges of the bag body, may be formed while said film for cover film is supplied, or a film for cover film, having the openings for installing the slider and notch portions for the welded portions, locating at both edges of the bag body, formed therein may be supplied.

In addition, according to the present invention, it is preferred that when said two plastic films, said plastic zipper and said film for cover film are welded together, welding is carried out while a heat insulating plate is inserted between a pair of flanges of said plastic zipper.

### Advantages of the Invention

According to the present invention, problems inherent to the above-described conventional methods for preventing unfairly unsealing has been solved, and the fact that the bag has been unsealed can easily be detected from its appearance when plastic zipper has been unsealed unfairly or by mistake. In other words, the cover film is damaged if the slider is moved in order to unseal unfairly, and therefore, the fact that the slider has been moved in a unsealing direction can readily be detected from its appearance.

Further, when a hermetic property is added to the plastic zipper itself, the present invention provides a bag body, having a plastic zipper with a slider equipped therewith, which is suitable for long time preservation and which can prevent unfairly unsealing.

Further, the present invention provides a method for manufacturing a bag body, having a zipper with a slider equipped therewith, which is excellent in productivity. More specifically, in the method for manufacturing a bag body according to the present invention, since at least one lower end of the cover film extends for full width of the bag body, while a continuous film itself bears a role of measure for transporting film for cover film, it can be supplied continuously as a film for cover film. After its role of measure for transporting a film for cover film has been finished, the continuous film for cover film is cut off together with the plastic film and the plastic zipper, which have been welded together, at a space, which is the same as the width of bag body at a perpendicular heat seal position, and bag bodies are formed.

Therefore, according to the present invention, provided is a bag body having a zipper with a slider equipped therewith and added thereto a preventive function against unfairly unsealing, which can be produced mechanically and consecutively, and its industrial productivity is superior, and provided is a method for manufacturing such a bag body.

In a bag body according to the present invention, a cover film rides astride and covers top portions of the plastic slider, under a condition wherein the plastic zipper is closed, and of the plastic zipper, except for a welded portion located opposite to the slider of the bag body.

The cover film can be readily peeled off if the cover film has a perforation or a weakened portion for separation formed thereon. In addition, the perforation or the weakened portion for separation is broken when the slider is moved in order to unfairly unseal, and the fact that the bag has been unsealed can easily be detected from its appearance.

### BRIEF DESCRIPTION OF THE DRAWINGS

The present invention will now be explained in detail referring to the attached drawings which illustrate some embodiments of the present invention, wherein:

FIG. 1 is a perspective view showing one embodiment of a bag body according to the present invention, which bag body has a plastic zipper with a slider equipped therewith and which is added thereto a preventive function against unfairly unsealing;

FIG. 2 is a perspective view of the bag body according to the present invention, which shows a condition wherein contents are packed into the bag body while one of the plastic films is not welded to plastic zipper;

FIG. 3(a) is a perspective view showing a shape of the cover film illustrated in FIG. 1, and FIG. 3(b) is a perspective view showing a shape of the cover film exemplified in FIG. 2;

FIG. 4(a) is a cross sectional view taken along line A-A in FIG. 1, and FIG. 4(b) is a cross sectional view taken along line C-C in FIG. 2;

FIG. 5(a) is a cross sectional view taken along line B-B in FIG. 1 in a condition wherein the bottom of the bag body in FIG. 1 is opened and wherein the heat sealed portion at the bottom like that in FIG. 1 is shown in an imaginary line, and FIG. 5(b) is a cross sectional view of a bag body according to the present invention, which bag body has a plastic zipper with a slider equipped therewith, which is added thereto a preventive function against unfairly unsealing, and which is being produced;

FIG. 6 is a perspective view showing a step in a method for manufacturing a plastic bag body according to the present invention having a preventive function against unfairly unsealing and having a plastic zipper with a slider equipped therewith, wherein the welded two plastic films, the plastic zipper and the film for cover film are welded together in a direction perpendicular to the supplying direction at a space so as to form welded portions locating at both edges of the bag body; and

FIG. 7 is a perspective view showing a method for manufacturing a plastic bag body according to the present invention having a plastic zipper with a slider equipped therewith, by means of an apparatus having a function of automatic bag producing machine.

### MODE FOR CARRYING OUT THE INVENTION

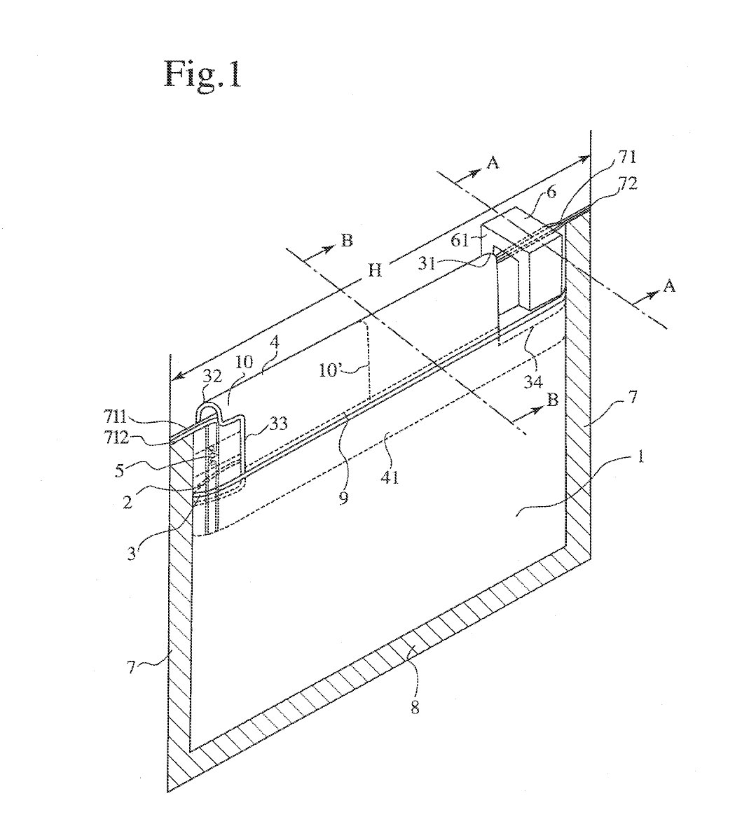

FIG. 1 is a perspective view showing one embodiment of a bag body according to the present invention. In FIG. 1, the left and right side ends and the bottom of two plastic films 2 and 3 are heat sealed 7 and 8 together, and a bag 1 is formed. A tape-like plastic zipper 5 is disposed at the opening mouth portion locating at the top of the bag 1, the plastic zipper 5 being equipped with a plastic slider 6.

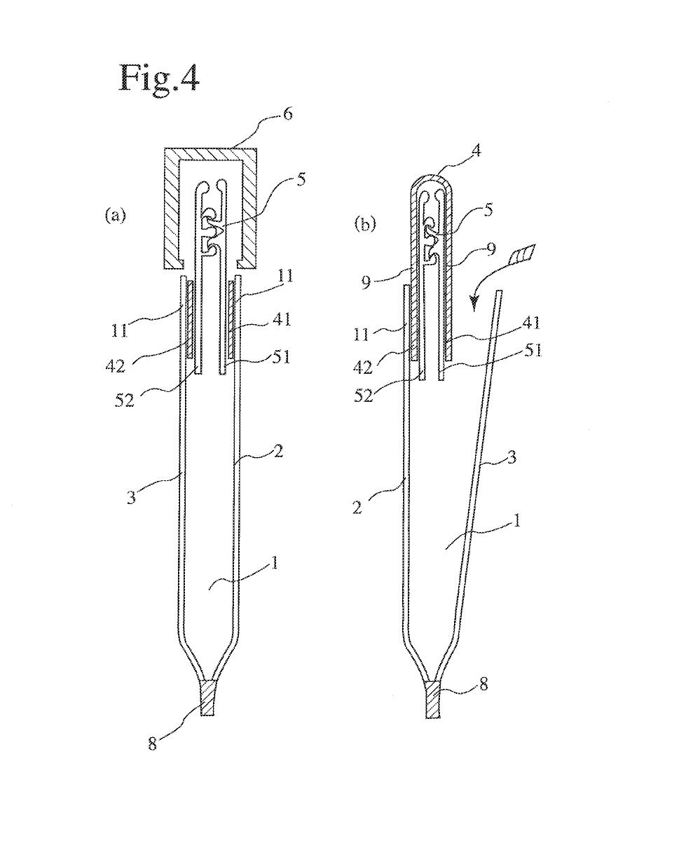

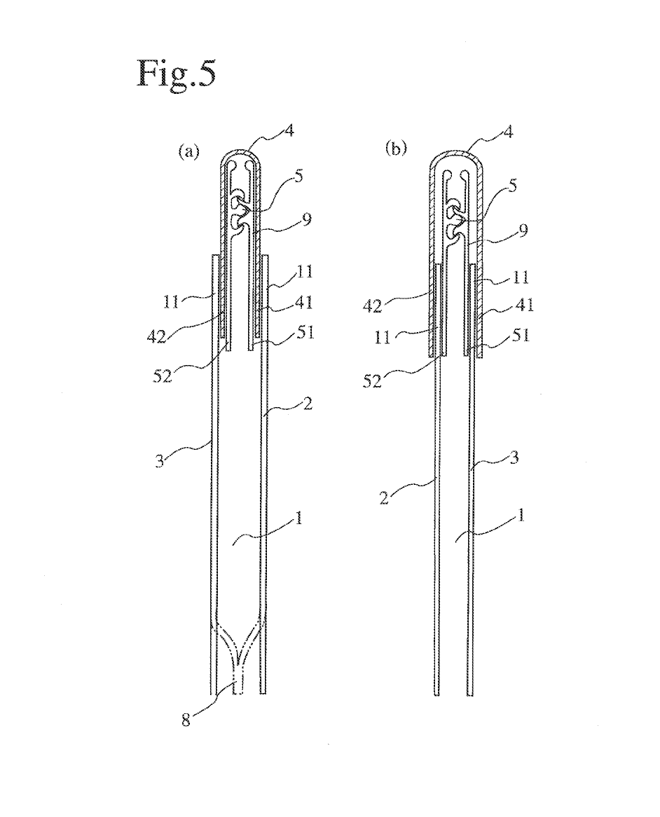

The tape-like plastic zipper 5 comprises a pair of tapes having, respectively, flanges 51 and 52 and male and female engaging portions, which engage with each other (see FIGS. 4 and 5).

The slider 6 slides along the plastic zipper 5, and it opens and closes the engaging portions of the plastic zipper 5. That is, when the slider 6 is located at the closed end position at one end 71 (the right side in FIG. 1) of the plastic zipper 5, the engaging portions of the plastic zipper 5 are fully closed. Contrary to this, when it is positioned at the other position (open end) 711 (the left side in FIG. 1), the engaging portions are fully opened.

The cover film 4 is folded down in a reverse U-shape, and it rides astride the top portion of the plastic zipper 5 and covers the upper surface of the top portion of the engaging portion of the plastic zipper 5. More specifically, the cover film 4 rides astride and covers the top portions of the plastic zipper 5, under a condition wherein the plastic zipper is closed, except for the plastic zipper, and a welded portion located opposite to the slider 6 of the bag body 1.

Due to this construction, the end 31 of the upper surface of the cover film 4 located near the closed end is positioned near the open end 711 relative to the end 61 of the slider 6 facing to the open end 711, and the end 32 of the upper surface of the cover film 4 is positioned near the closed end 71 relative to the open end 711.

As illustrated in FIGS. 4(a) and 5(a), two lower ends 41 and 42 of the cover film 4 reach the flange portions 51 and 52 which are located below the engaging portion of the plastic zipper 5. At least one 41 or 42 of the two lower ends 41 and 42 of the cover film 4 extends through full width (a distance between the heat seals 7 and 7′ at both the ends) of the bag 1 (the distance is H) as illustrated in FIG. 1.

At least one of the two lower ends 41 and 42 of the cover film 4 is overlapped with the upper ends of the plastic films 2 and 3 forming the bag 1 and with the flange portion 51 of the plastic zipper 5 as illustrated in FIG. 4(a). The plastic films 2 and 3, the lower ends 41 and 42 of the cover film 4 and the flange portions 51 and 52 of the plastic zipper 5 are melted and bonded (i.e., heat sealed at 11) at a position which is below (side towards contents) relative to the lower ends of the slider 6 as illustrated in FIG. 5(a).

Please note that in the embodiment illustrated in FIG. 5(a), the plastic films 2 and 3, the lower ends 41 and 42 of the cover film 4 and the flange portions 51 and 52 of the plastic zipper 5 are piled up from outside in this order.

Contrary to this, the embodiment illustrated in FIG. 5(b) is different from the embodiment illustrated in FIG. 5(a) in that the lower ends 41 and 42 of the cover film 4 are located outside the overlapped flange portions 51 and 52 of the plastic zipper 5 and the upper ends of the plastic films 2 and 3 forming the bag 1.

It is preferred that the lower ends 41 and 42 of the cover film 4 are positioned almost the same as the lower ends of the flange portions 51 and 52 of the plastic zipper 5.

A distance between the slider 6 in a condition wherein the plastic zipper 5 is closed and the side edge 31 of the cover film 4 facing to the slider 6 is set not more than 5 mm. The reverse U-shaped top portion of the cover film 4 is lower than the top portion of the slider 6 in a condition wherein the plastic zipper 5 is closed.

As illustrated in FIG. 1, the upper surface 34 of the cover film 4, locating between the side edge 72 of the bag at the closed end and the side edge 31 of the cover film 4 at the closed end, and the upper surface 35 of the cover film, locating between the side edge 712 of the bag at the open end and side edge 33 of the cover film 4 at the open end, are preferably located at a position lower than the lower edges of the slider 6 and are made substantially parallel to the plastic zipper 5.

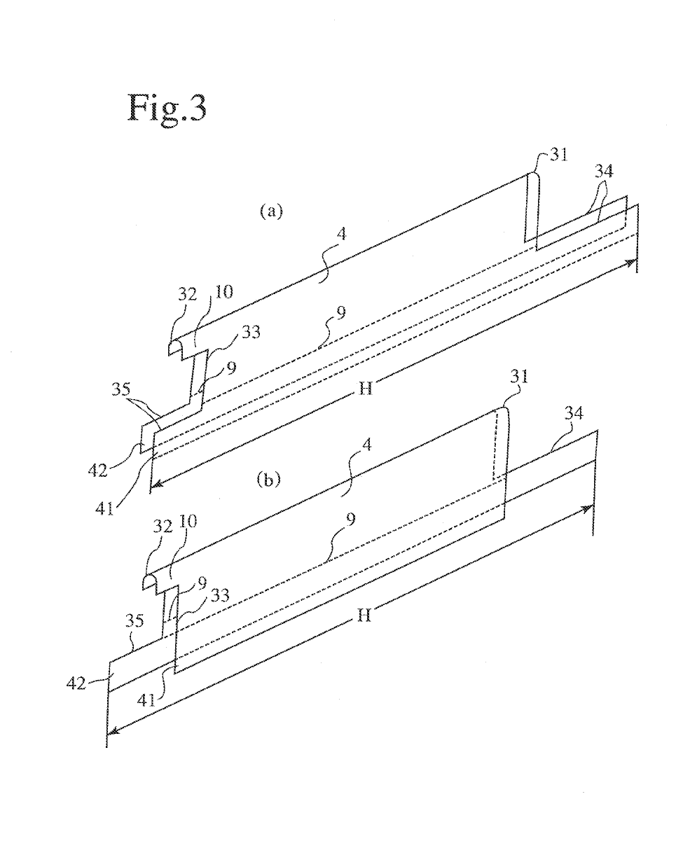

The shape of the cover film 4 illustrated in FIG. 1 is illustrated in FIG. 3(a). As illustrated in FIG. 3(a), the cover film 4, which is two-folded in a reverse U-shaped cross section, is vertically symmetric in a cross sectioned condition. Nevertheless, as long as at least one end 41 of the two ends 41 and 42 of the cover film 4 extends for full width (i.e., a distance between the heat seals 7, 7′ of both the side ends) of the bag 1 (the distance is H), the shape of the cover film 4 may be another shape, for example, it may be such a shape as shown in FIG. 3(a).

It is preferred that a perforation or a weakened portion 9 for separation which can be broken, extending in a widthwise direction of the bag body (i.e., it extends from the side 31 at the closed end to the side at the open end 33), is disposed on the upper surface or side surface of the cover film 4. It is preferred that the number of the perforation or the weakened portion 9 for separation is about 1 to 3. It is desirable to dispose it in parallel with the plastic zipper 5.

Further, in the embodiments illustrated in FIGS. 3(a) and 3(b), a grip 10 is disposed on the cover film 4 at a position near the welded portion 7 of the bag body 1 locating opposite to the slider 6 in a closed condition (that is, at the edge 33 near the open end of the cover film 4). When the bag body 1 is opened, the weakened portion 9 for separation such as a perforation is broken by pulling up the grip 10, and the cover film 4 can be stripped off.

Since the weakened portion 9 such as the perforation is broken and since the cover film 4 is stripped, too, by means of the sliding movement of the slider 6 from the closed end 71 towards the open end 711, the fact that the bag has been opened is clearly demonstrated.

It is preferred that the grip 10 is disposed when the cover film 4 is stripped off during a normal opening operation before the slider 6 is moved. However, the cover film 4 may be stripped off, too, by the movement of the slider 6. If the slider is moved while the cover film 4 has not been stripped off, the cover film between the end 31 at the closed end and the end 33 at the open end is stripped off by means of the sliding movement of the slider 6. In this occasion, the grip 10 may be omitted.

When the distance between the end 31 of the cover film 4 at the closed end and the end 33 of the cover film 4 at the open end is so long that the stripped off cover film 4 is entangled with the slider 6, more than one slit 10′, comprising a perforation or a weakened portion, may be disposed at a position between the end 31 at the closed end and the end 33 at the open end so that portions stripped off from the cover film 4 are separated into appropriate number of pieces. It is preferred that as illustrated in FIG. 1, the slit 10′ extends from the reverse U-shaped top portion of the cover film 4 and at least goes across the lower perforation or weakened portion 9 so that it reaches a position almost the same as the upper surfaces 34 and 35 of the cover film 4.

As described above, the cover film 4 is stripped off if the plastic zipper is partially opened by the slider 6, the fact that the bag body has been opened is clearly demonstrated.

Incidentally, since the cover film 4 has a structure which is open at its end portion, the plastic zipper may be unable to be sealed hermetically only by means of the cover film 4. For the counter-measure, it is preferred to guarantee hermetic sealing of the plastic zipper 5 by means of, for example, A or B which will be described later.

A: Top portions of the plastic films 2 and 3 of the bag body 1, where the slider 6 is stopped under a condition wherein the plastic zipper 5 is closed, or the plastic zipper 5 are heat sealed so that hermetic sealing of the plastic zipper 5 is guaranteed even if the slider 6 slightly changes its position from the above-mentioned stopped position.

B: As the inventor of the present invention disclosed in the patent document 2 (WO2005/048763 A1), hermetic sealing of the plastic zipper 5 is guaranteed by applying to the present invention the plastic zipper 5 wherein an easily peelable plastic layer has been disposed previously on a surface of a top of a female hook, forming an engaging portion, or a surface of a flange portion of a male hook facing to the top of the female hook.

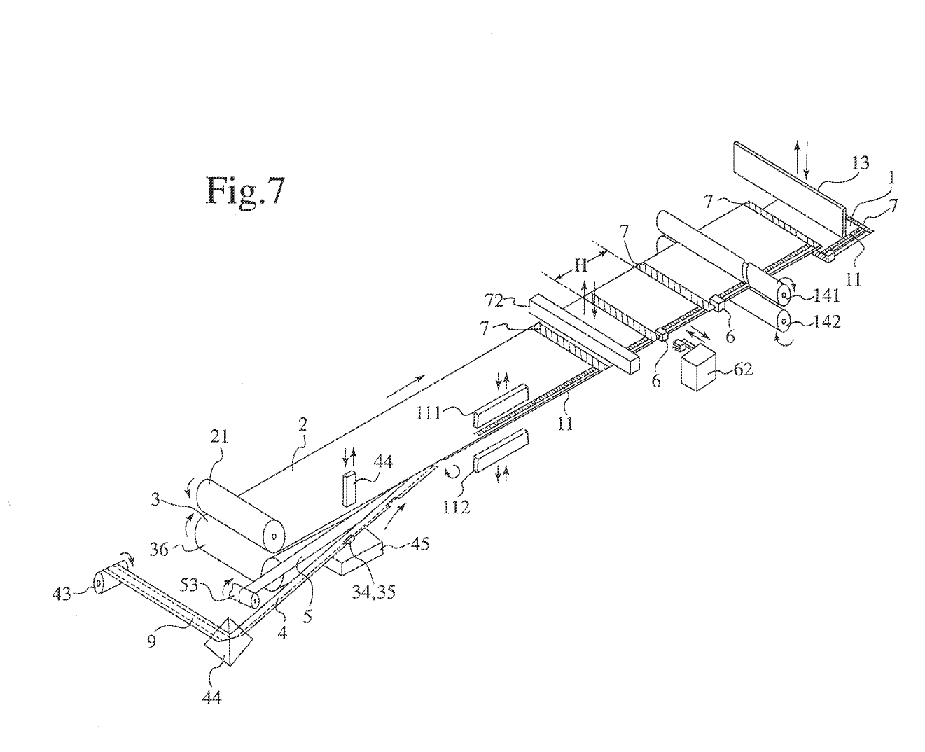

Referring to FIG. 7, will be explained a method for manufacturing the embodiment of a bag body of the present invention, having been illustrated in FIG. 1, having a plastic zipper with a slider equipped therewith and added thereto a preventive function against unfairly unsealing.

Two tape-like films 2 and 3, which will form a bag 1 and which are wound onto reels 21 and 22, respectively, are prepared. Further, a tape-like film 4 for cover film, which is wound onto a reel 43, is prepared. The tape-like film 4 for cover film has a weakened portion 9 for separation such as a perforation disposed thereon. A tape-like zipper 5, wound onto a reel 53, is prepared.

The two tape-like films 2 and 3 are withdrawn intermittently from the reels 21 and 36 by a length H by means of withdrawing rolls 141 and 142 which are driven intermittently. The tape-like zipper 5 is withdrawn from the reel 53. Further, the tape-like film 4 for cover film, which will be adhered to the plastic films as will be described later, is withdrawn intermittently from the reel 43 by a length H, while it synchronizes with the tape-like films 2 and 3, and it is folded in two by means of a folding machine.

While the withdrawing rolls 141 and 142, which are driven intermittently, are stopped, an opened portion (a notch portion 31-35) for installing the slider 6 is formed on the film 4 for cover film, which has been folded in two, by the vertical movement of a blanking presses 44 and 45. After an opened portion (a notch portion 31-35) for installing the slider 6 is formed previously by the blanking presses 44 and 45 on the film 4 for cover film, the film 4 for cover film may be folded in two by means of a folding machine.

The two folded film 4 for cover film is forwarded in such a manner that it rides astride the tape-like plastic zipper tape 5, and the two plastic films 2 and 3, the tape-like plastic zipper 5 and the film 4 for cover film are put together, and they are welded together to form side heat seals 11 in a supplying direction by means of a side heat sealing machines 111 and 112, which are disposed in a supplying direction, when the withdrawing rolls 141 and 142, which are intermittently driven, are stopped.

When the two plastic films 2 and 3, the plastic zipper 5 and the film 4 for cover film are welded, it is preferred to weld them in a condition that a heat insulating plate (not shown) such as an iron plate is inserted between a pair of flanges 51 and 52 of the plastic zipper 5. As a result, the plastic film 2, the flange 51 of the plastic zipper 5 and the lower end 41 of the film 4 for cover film, and the plastic film 3, the flange 52 of the plastic zipper 5 and the lower end 42 of the film 4 for cover film can be welded while a pair of flanges 51 and 52 of the plastic zipper 5 is prevented from being welded together.

When the withdrawing rolls 141 and 142, which are driven intermittently, is stopped, the vertical heat sealing machine 72, which is disposed perpendicularly to the supplying direction of films 2 and 3, moves vertically (i.e., upwards and downward) and welds to form vertical heat seals 7 at a space, which is the same as the width of the bag body, in a direction perpendicular to the supplying direction at appropriate positions corresponding to the notch portions of the film 4 for cover film, so that the welded portions 7 at both the ends of the bag body are formed.

A slider installing machine 62 is disposed at the side of a transporting way of the films 2 and 3 locating downstream the vertical heat sealing machine 72. When the withdrawing rolls 141 and 142, which are driven intermittently, is stopped, the slider installing machine 62 moves forward and backward in a direction perpendicular to the transporting way of the films 2 and 3 so that it installs the sliders 6 at the positions on the plastic zippers 5 of the closed ends of the bags 1 through openings (notch portion 31-˜35) for installing the sliders on the film 4 for cover film.

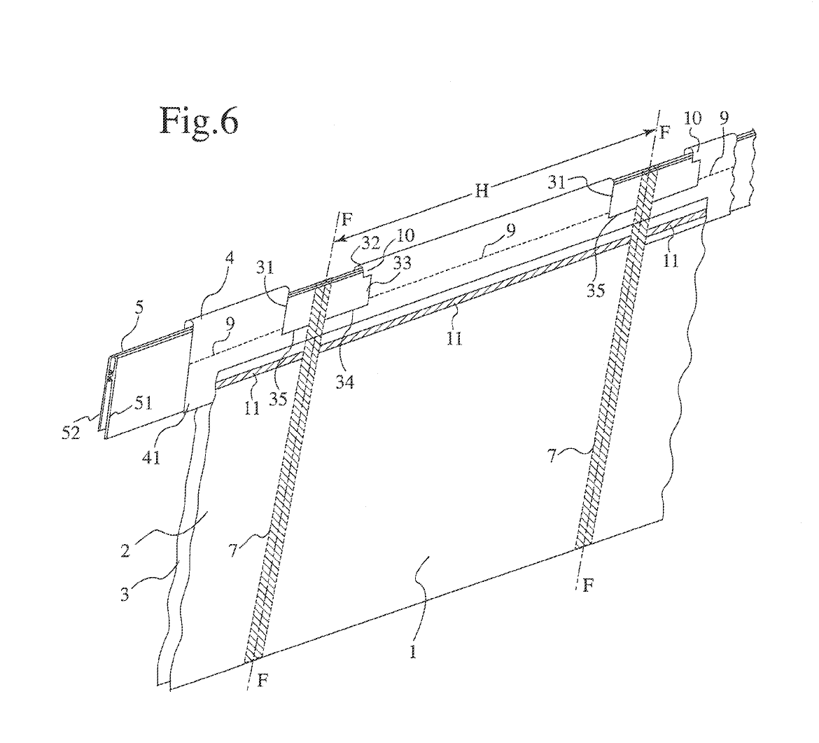

Further, a guillotine cutter 13 is disposed downstream the slider installing machine 62. When the withdrawing rolls 141 and 142, which are driven intermittently, is stopped, the guillotine cutter 13 moves vertically, i.e., upward and downward, and it cuts the films 2 and 3 at the central lines F-F of the vertical heat seals 7 as illustrated in FIG. 6, so that it cuts the melted portions 7 for both the side ends of the bag bodies 1 in a direction perpendicular to the supplying direction.

Thus, the heat seals 7 are formed at both the side ends, and as illustrated in FIG. 5(a), obtained is a bag body 1, the lower end of which is opened, which has a plastic zipper with a slider equipped therewith, and which is added thereto a preventive function against unfairly unsealing. Since all the above-described steps can be carried out by means of a bag producing machine, its productivity is extremely excellent, and its production cost is inexpensive.

Two embodiments of methods for filling contents into the bag body 1 of the present invention, which has a plastic zipper with a slider equipped therewith and which is added thereto a preventive function against unfairly unsealing, will now be explained.

In the embodiment illustrated in FIGS. 5(A) and 5(B), the bottom of the bag body 1 is opened. The bag body 1 is laid on its side or it is turned upside down, contents are filled into the bag body 1 from the bottom of bag body 1 as illustrated in FIGS. 5(A) and 5(B). Subsequently, the bottom of the bag body 1 is sealed by means of a heat seal 8 as illustrated in an imaginary line in FIG. 5(a).

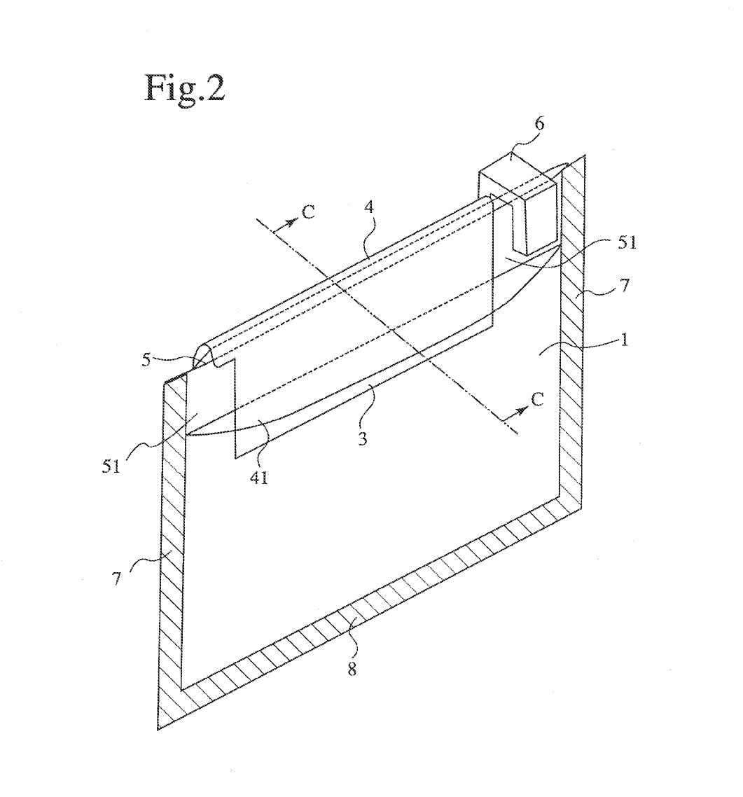

Meanwhile, in the embodiment illustrated in FIGS. 2 and 4(b), which is a cross sectioned view along line C-C in FIG. 2, one of lower end 42 of the film 4 for cover film, the flange portion 52 of the plastic zipper 5 and only the upper portion of film 2 forming the bag body 1 are put together and are heat sealed. On the other hand, the upper portion of the other film 3 is separated from the lower end 41 of the film 4 for cover film and from the flange portion 51 of the plastic zipper 5 so that an open mouth for filling contents is formed. Contents are filled into the inside of the bag body 1 through the open mouth in a direction of arrow illustrated in FIG. 4(b).

Thereafter, the separated upper portion of the film 3 is overlapped with the lower end 41 of the film 4 for cover film and the flange portion 51 of the plastic zipper 5, and they are hermetically heat sealed at heat seal line 11.

Further, in the embodiment illustrated in FIG. 4(b), two films 2 and 3 forming a bag body 1 are heat sealed at the bottoms of the bag body 1. However, one film forming a bag body 1 may be used and it may be folded back at its bottom.

In the above described heat sealing operation at seal line 11, if a heat insulating plate (not shown), such as an iron plate, is inserted between a pair of flanges 51 and 52 of the plastic zipper 5 so as to prevent the pair of flanges 51 and 52 of the plastic zipper 5 from being welded, the heat insulating plate can not be taken out because the bag body 1 is closed by the heat sealing at the upper end of the film 3.

By taking the following measures a, b or c instead of insertion of the heat insulating plate, film 3, the lower end 41 of the film for cover film and the flange portion 51 of the plastic zipper 5 are welded while the pair of flanges 51 and 52 of the plastic zipper 5 are not welded.

a. Strict heat sealing conditions (such as heat sealing temperature, heat sealing time duration and so on) are selected wherein the film 3, the lower end 41 of the film for cover film and the flange portion 51 of the plastic zipper 5 are welded and wherein however, the pair of flanges 51 and 52 of the plastic zipper 5 are not welded.

b. As the inventor of the present invention proposed in Japanese Patent Application Laid-open No. 2002-337892, special materials are selected for the flanges 51 and 52 of the plastic zipper 5.

c: Alternatively, as the inventor of the present invention proposed in the above-described Laid-open Japanese Patent Application, minute unevenness is formed on the surface of the flange 51 and 52.

### EXPLANATION OF THE REFERENCE NUMERALS

1 bag body
2, 3 plastic film
4 cover film
31 end of the cover film at the closed end
32 end 32 of the cover film at the open end
33 side edge of the cover film at the open end
34 upper surfaces of the cover film between the side of the bag at the closed end and the end of the cover film at the closed end
35 upper surfaces of the cover film between the side of the bag at the open end and the side edge of the cover film at the open end
41, 42 lower end of the cover film
5 tape-like plastic zipper
51, 52 flange of the plastic zipper
71 closed end of the plastic zipper
711 open end of the plastic zipper
6 slider
61 end 61 of the slider 6 facing to the open end
7 heat seal at the ends of the bag
8 heat seal at the bottom of the bag
9 perforation or weakened portion for separation
10 grip
10′ slit
11 side heat seal
13 guillotine cutter
21, 36 reel of a tape-like film
43 reel of a tape-like film for cover film
44, 45 blanking press
53 reel of a tape-like plastic zipper
62 slider installing machine
72 vertical heat sealing machine
111, 112 side heat sealing machine
141, 142 withdrawing rolls which are driven intermittently
H distance of lower end of the cover film along the plastic zipper

1-10. (canceled)

11. A plastic bag body having a preventive function against unfairly unsealing, the bag body comprising:
a bag made of two plastic films that are welded together, wherein the bag includes an open portion;
a plastic zipper with a slider at the open portion of the bag, wherein the plastic zipper includes engaging portions, flange portions located below the engaging portions, an open end, and a closed end;
a cover film, which is folded in such a manner that a top portion of the cover film directs upward and is lower than a top portion of the slider in a condition wherein said plastic zipper being closed, rides astride and covers top portions of said plastic zipper, under a condition wherein said plastic zipper is closed, except that said cover film does not cover said slider and a welded portion of said bag body located opposite to said slider, wherein:
two lower ends of said cover film reach the flange portions located below the engaging portions of said plastic zipper,
at least one of the lower ends of said cover film extends for the full width of said bag body,
the lower ends of said cover film are put together with the plastic films forming said bag body and with the flange portions of said plastic zipper,
said plastic film, said lower ends of said cover film and said flange portions are welded together, and
the cover film and the slider are configured such that the cover film is stripped off, without being ruptured, only by movement of the slider from the closed end of the plastic zipper to the open end of the plastic zipper.

12. The plastic bag body of claim 11, wherein a distance between the slider in a condition wherein said plastic zipper is closed and the edge of said cover film adjoining to said slider is not more than 5 mm.

13. The plastic bag body of claim 11, wherein said cover film has a perforation or a weakened portion for separation, extending in a widthwise direction of said bag body, disposed thereon.

14. The plastic bag body of claim 13, wherein said cover film has a grip at a position close to the welded portion of the bag body, the welded portion being located opposite to said slider in a condition wherein said plastic zipper is closed.

15. The plastic bag body of claim 13, wherein said cover film has a slit disposed thereon and extending from the top portion thereof to at least said perforation or said weakened portion for separation, the slit comprising a perforation or a weakened portion for separation.

16. A method for manufacturing a plastic bag body having a preventive function against unfairly unsealing and having a plastic zipper with a slider equipped therewith, the method comprising:
supplying two continuous plastic films which form the bag;
supplying to said two continuous plastic films a continuous plastic zipper and a two-folded continuous film for cover film having openings for installing the slider;
supplying said two-folded continuous film for cover film in such a manner that the two-folded portion of said two-folded continuous film for cover film is outside the slider installing openings, and said two-folded continuous film rides astride said plastic zipper;
putting said two plastic films, said plastic zipper and said film for cover film together, and welding said two plastic films, said plastic zipper and said film for cover film in a supplying direction;
welding said welded two plastic films, said plastic zipper and said film for cover film in a direction perpendicular to said supplying direction at a space, the space defining a width of a bag body, so as to form welded portions located at both edges of the bag body and extending in a direction perpendicular to said supplying direction;
installing said slider to said plastic zipper through said openings for installing the slider in such a manner that the top portion of said cover film directs upward and is lower than the top portion of the slider in a condition wherein said plastic zipper is closed, wherein the cover film and the slider are configured such that the cover film is stripped off, without being ruptured, only by movement of the slider from a closed end of the plastic zipper to an open end of the plastic zipper; and
cutting the welded portions located at both edges of the bag body and extending in a direction perpendicular to said supplying direction.

17. The method of claim 16, further comprising forming the openings for installing the slider and the welded portions located at both edges of the bag body while said two-folded continuous film for cover film is supplied.

18. The method of claim 16, wherein a film for cover film having the openings for installing the slider and the welded portion located at both edges of the bag body formed therein is supplied.

19. The method of claim 16, wherein, when said two plastic films, said plastic zipper and said film for cover film are welded together, welding is carried out while a heat insulating plate is inserted between a pair of flanges of said plastic zipper.

20. The plastic bag body of claim 11, wherein the cover film includes at least two perforations or weakened portions for separation extending in a widthwise direction of said bag body, and the cover film and slider are configured such that movement of the slider from the closed end of the plastic zipper to the open end of the plastic zipper will strip off the cover film along the perforations or weakened portions.

21. The method of claim 16, wherein the cover film includes at least two perforations or weakened portions for separation extending in a widthwise direction of said bag body, and the cover film and slider are configured such that movement of the slider from the closed end of the plastic zipper to the open end of the plastic zipper will strip off the cover film along the perforations or weakened portions.
